(19) United States
(12) Patent Application Publication
(10) Pub. No.: US 2019/0285026 A1
(43) Pub. Date: Sep. 19, 2019

(54) SEAL RETAINER FOR INTERNAL COMBUSTION ENGINE

(71) Applicant: TOYOTA JIDOSHA KABUSHIKI KAISHA, Aichi-ken (JP)

(72) Inventor: Shigeki YASUHARA, Toyota-shi (JP)

(21) Appl. No.: 16/273,158

(22) Filed: Feb. 12, 2019

(30) Foreign Application Priority Data
Mar. 19, 2018 (JP) 2018-050631

(51) Int. Cl. F02F 11/00; F16J 15/3268; F16J 15/3204; F16J 15/3252

(52) U.S. Cl. CPC F02F 11/007; F16J 15/3252; F16J 15/3204; F16J 15/3268

(57) ABSTRACT

A seal retainer includes a main body and a guide wall. The main body includes a circular hole, an opposed surface opposed to the cylinder block, and a projection. The flange is arranged in the circular hole with the sealing member located between the circular hole and the flange. The projection includes a recess at a part of the projection in the circumferential direction of the circular hole. The recess extends from the distal end of the projection in an opposite direction from the cylinder block. The guide wall is arranged outward of the recess in a radial direction of the circular hole to guide air that flows in the circumferential direction of the circular hole from the radially outer side of the projection to the radially inner side of the projection through the recess.

### BACKGROUND

The present disclosure relates to a seal retainer for an internal combustion engine

The internal combustion engine disclosed in Japanese Laid-Open Patent Publication No. 2007-232181 includes a crankshaft extending in an axial direction. A first end of the crankshaft projects from the outer surface of the cylinder block. The crankshaft includes a disk-like flange, which extends radially outward from the first end. A flywheel is mounted on an end face of the flange in the axial direction with, for example, bolts.

A seal retainer is mounted on part of the outer surface of the cylinder block where the crankshaft projects. The seal retainer includes a plate-shaped main body, which is arranged to be opposed to the outer surface of the cylinder block. The main body includes a circular hole extending through the main body. The flange of the crankshaft is arranged in the circular hole. An annular sealing member is arranged between the inner circumferential surface of the circular hole and the outer circumferential surface of the flange. The sealing member hermetically seals between the seal retainer and the flange of the crankshaft.

When the crankshaft in the internal combustion engine of the above publication rotates, the temperature of the sealing member may increase due to friction between the sealing member and the flange of the crankshaft. When the temperature of the sealing member excessively increases, the sealing member may possibly be damaged due to thermal expansion, and the flange and the seal retainer may possibly be no longer hermetically sealed.

### SUMMARY

In accordance with one aspect of the present disclosure, a seal retainer for an internal combustion engine is provided. The engine includes a cylinder block, a crankshaft having a first end projecting from an outer surface of the cylinder block in an axial direction and a flange extending radially outward from an outer circumferential surface of the first end, and an annular sealing member arranged around an outer circumferential surface of the flange. The seal retainer includes a plate-shaped main body arranged to be opposed to the outer surface of the cylinder block, and a guide wall. The main body includes a circular hole extending through the main body, an opposed surface opposed to the cylinder block, and a projection, which projects from the opposed surface toward the cylinder block and extends along an inner circumferential edge of the circular hole. The flange is arranged in the circular hole with the sealing member located between an inner circumferential surface of the circular hole and the outer circumferential surface of the flange. The projection includes a recess at a part of the projection in a circumferential direction of the circular hole. The recess extends from a distal end of the projection in an opposite direction from the cylinder block. The guide wall is arranged outward of the recess in a radial direction of the circular hole to guide air that flows in the circumferential direction of the circular hole from a radially outer side of the projection to a radially inner side of the projection through the recess.

Other aspects and advantages of the present disclosure will become apparent from the following description, taken in conjunction with the accompanying drawings, illustrating by way of example the principles of the disclosure.

### BRIEF DESCRIPTION OF THE DRAWINGS

The disclosure, together with objects and advantages thereof, may best be understood by reference to the following description of the presently preferred embodiments together with the accompanying drawings in which:

FIG. 1 is a schematic cross-sectional view of a cylinder block on which a seal retainer of the present embodiment is mounted and the surrounding structure;

FIG. 2 is a perspective view of the seal retainer of FIG. 1;

FIG. 3 is a partial perspective view of the seal retainer of FIG. 2; and

FIG. 4 is a partial perspective view of the seal retainer showing a guide wall according to a modification.

### DETAILED DESCRIPTION

A seal retainer 50 for an internal combustion engine E according to an embodiment will be described with reference to the drawings. The internal combustion engine E of the present embodiment is mounted on a vehicle. The vertical direction in a state in which the internal combustion engine E is mounted on the vehicle is referred to as the vertical direction of the internal combustion engine E and the seal retainer 50.

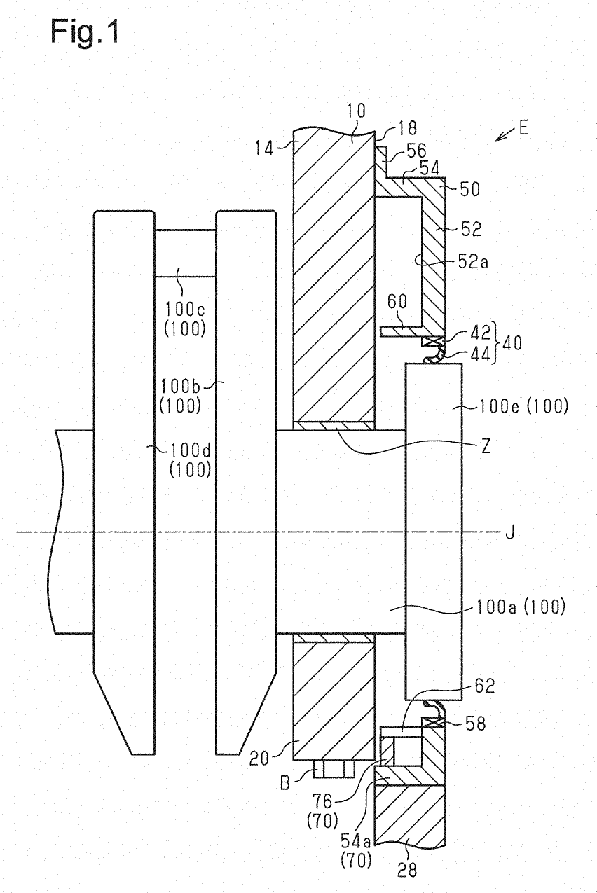

As shown in FIG. 1, the internal combustion engine E includes a cylinder block 10 and a crankshaft 100, which generally extends in an axial direction (left-and-right direction in FIG. 1). The crankshaft 100 includes sets of a substantially columnar journal 100a, crank weights 100b, 100d, and a crank pin 100c. The number of the sets is the same as the number of the cylinders of the internal combustion engine E. An axis J of each journal 100a matches with the axis J of the crankshaft 100. The journal 100a, the crank weight 100b, the crank pin 100c, and the crank weight 100d included in one set are arranged in this order along the axis J from a first end (right end in FIG. 1) toward a second end (left end in FIG. 1) in the axial direction.

The substantially plate-shaped crank weight 100b is mounted on a second end face of each journal 100a in the axial direction. The crank weight 100b is substantially sectorial in a plan view from the axial direction of the journal 100a. The mounting position of the crank weight 100b relative to the journal 100a is determined in such a manner that the center of gravity of the crank weight 100b deviates from the axis J.

The substantially columnar crank pin 100c is secured to a second end face of the crank weight 100b in the axial direction. The crank pin 100c is secured to a position displaced from the axis J. A non-illustrated connecting rod is coupled to the crank pin 100c, and reciprocation of the associated piston is transmitted to the crank pin 100c (the crankshaft 100) through the connecting rod. The substantially plate-shaped crank weight 100d is mounted on a second end face of the crank pin 100c in the axial direction. The crank weight 100d has substantially the same shape as the crank weight 100b. The crank weight 100d is placed relative to the journal 100a in the same manner as the crank weight 100b.

Although not shown, multiple sets of the journal 100a, the crank weights 100b, 100d, and the crank pin 100c are arranged in the axial direction of the journal 100a.

One of the journals 100a arranged on a first end of the crankshaft 100 in the axial direction, which will be referred to as the first journal 100a, includes a disk-like flange 100e. The disk-like flange 100e extends radially outward from the outer circumferential surface of the first journal 100a. The flange 100e is arranged on a first end of the first journal 100a in the axial direction. A non-illustrated flywheel is mounted on the outer end face of the flange 100e on the opposite side from the first journal 100a with, for example, bolts.

The first journal 100a is supported between a side wall 14 of the cylinder block 10 and a crank cap 20, which is mounted on the lower surface of the side wall 14. The crank cap 20 is secured to the side wall 14 of the cylinder block 10 with bolts B. An annular plain bearing Z is arranged between the side wall 14 and the crank cap 20. The plain bearing Z rotationally supports the crankshaft 100 (the first journal 100a). The first end of the journal 100a in the axial direction projects from an outer surface 18 of the cylinder block 10. Thus, the flange 100e of the crankshaft 100 is located outside the cylinder block 10.

A generally annular sealing member 40 is arranged around the outer circumferential surface of the flange 100e. The sealing member 40 includes an annular metal core 42 and an annular seal lip 44, which is attached to the inner circumferential section of the metal core 42. The seal lip 44 extends along the entire circumference of the metal core 42 and contacts the outer circumferential surface of the flange 100e. The seal lip 44 is made of an elastic body such as rubber. In a state in which the seal lip 44 is not arranged around the outer circumferential surface of the flange 100e, the inner diameter of the seal lip 44 is slightly smaller than the outer diameter of the flange 100e. A gap between the inner circumferential surface of the seal lip 44 and the outer circumferential surface of the flange 100e is filled with the seal lip 44 when the seal lip 44 is pressed against and deformed with respect to the outer circumferential surface of the flange 100e.

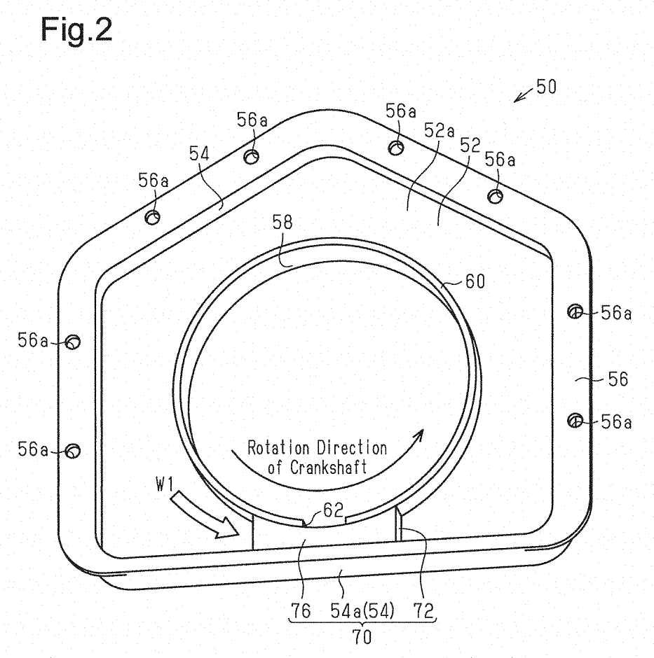

The seal retainer 50 is mounted on the outer surface 18 of the cylinder block 10. As shown in FIG. 2, the seal retainer 50 includes a plate-shaped main body 52 and a guide wall 70. The main body 52 is shaped substantially like a pentagon in a plan view. More specifically, in a state in which the seal retainer 50 is mounted on the cylinder block 10, the main body 52 is shaped like a pentagon including a lower side extending in a direction orthogonal to the vertical direction, a pair of sides extending upward from the ends of the lower side, and a pair of oblique sides extending obliquely upward from the upper ends of the pair of sides to approach each other. The upper ends of the pair of oblique sides meet each other and form a vertex arranged above the lower side. The area of the main body 52 in a plan view is greater than the area of the flange 100e of the crankshaft 100 in a plan view.

The seal retainer 50 includes a circumferential wall 54, which projects from the outer edge of the main body 52 in the thickness direction (leftward in FIG. 1). In the present embodiment, the circumferential wall 54 projects in a direction substantially orthogonal to the surface of the main body 52. Furthermore, the circumferential wall 54 extends along the entire outer edge of the main body 52.

The seal retainer 50 has a flat rim 56, which projects outward (in a direction away from the axis J) from the distal end of the circumferential wall 54. The rim 56 projects in a direction orthogonal to the circumferential wall 54. The rim 56 projects from the part of the circumferential wall 54 extending along the pair of sides and the pair of oblique sides of the main body 52. In other words, the rim 56 does not project from the part of the circumferential wall 54 corresponding to a lower circumferential wall 54a extending along the lower side of the main body 52.

The rim 56 includes coupling holes 56a, which extend through the rim 56 along the thickness. The coupling holes 56a are arranged along the outer edge of the main body 52.

The main body 52 includes a circular hole 58, which extends through the main body 52 along the thickness (in the axial direction). The circular hole 58 has a circular cross section. The diameter of the circular hole 58 is greater than the diameter of the flange 100e of the crankshaft 100 and is substantially the same as the outer diameter of the metal core 42 of the sealing member 40. The center of the circular hole 58 is arranged closer to the lower side than the center of the main body 52 between the lower side and the vertex of the main body 52.

A projection 60 projects from an opposed surface 52a, which is a second end face of the main body 52 in the thickness direction (axial direction). In the present embodiment, the direction in which the projection 60 projects is substantially perpendicular to the surface of the main body 52 and is the same as the direction in which the circumferential wall 54 projects. The projecting length of the projection 60 is slightly smaller than the projecting length of the circumferential wall 54. The projection 60 extends generally in an annular shape along the inner circumferential edge of the circular hole 58. The inner circumferential surface of the projection 60 is flush with the inner circumferential surface of the circular hole 58.

As shown in FIG. 1, in a state in which the seal retainer 50 is mounted on the outer surface 18 of the cylinder block 10, the opposed surface 52a of the main body 52 is opposed to the outer surface 18 of the cylinder block 10. The projection 60 projects from the main body 52 toward the cylinder block 10. The lower side of the main body 52 is the lower edge of the main body 52. The rim 56 of the seal retainer 50 abuts against the outer surface 18 of the cylinder block 10. Non-illustrated bolts are inserted in the coupling holes 56a of the rim 56 from the side opposite from the cylinder block 10. The bolts are screwed to the cylinder block 10. In this manner, the seal retainer 50 is mounted on the cylinder block 10 with the bolts. The lower section of the main body 52 is arranged at a position opposed to the crank cap 20. The lower circumferential wall 54a is arranged to be lower than the crank cap 20. A gap is provided between the lower circumferential wall 54a and the crank cap 20.

The flange 100e is arranged in the circular hole 58 of the seal retainer 50 with the sealing member 40 arranged between the inner circumferential surface of the circular hole 58 and the outer circumferential surface of the flange 100e. The outer circumferential surface of the metal core 42 abuts against and is secured to the inner circumferential surface of the circular hole 58. In this manner, the sealing member 40 closes the space between the inner circumferential surface of the circular hole 58 of the seal retainer 50 and the outer circumferential surface of the flange 100e. This prevents oil that has leaked from between the journal 100a of the crankshaft 100 and the plain bearing Z from further leaking outside the seal retainer 50. The seal retainer 50 is mounted on the outer surface 18 of the cylinder block 10 with the sealing member 40 attached to the circular hole 58 of the seal retainer 50.

An oil pan 28 for storing oil is secured to the lower section of the cylinder block 10. Part of the upper end face of the oil pan 28 abuts against the outer surface (lower surface) of the lower circumferential wall 54a of the seal retainer 50. The inside of the oil pan 28 communicates with the space surrounded by the outer surface 18 of the cylinder block 10 and the seal retainer 50 through the gap between the lower circumferential wall 54a of the seal retainer 50 and the crank cap 20.

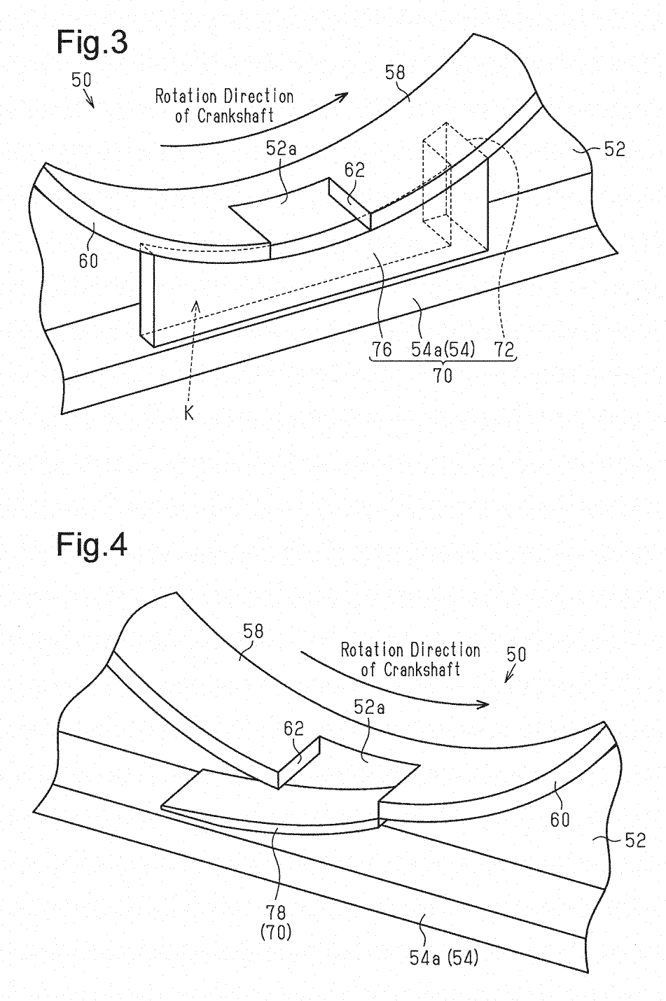

As shown in FIGS. 2 and 3, the projection 60 includes a recess 62 at the section closest to the lower circumferential wall 54a. As described above, since the lower side of the main body 52 is lower than the other four sides, the recess 62 is located at the lowest section of the projection 60. The recess 62 extends from the distal end of the projection 60 toward the main body 52 (away from the cylinder block 10). The recess 62 is substantially rectangular as viewed from the radial direction of the circular hole 58. In the present embodiment, the depth of the recess 62 matches with the projecting length of the projection 60. That is, the bottom surface of the recess 62 is flush with the opposed surface 52a of the main body 52.

As shown in FIG. 3, the guide wall 70 is arranged outward of the recess 62 in the radial direction of the circular hole 58. The guide wall 70 is provided to guide air that flows in the circumferential direction of the circular hole 58 from the radially outer side of the projection 60 to the radially inner side of the projection 60 through the recess 62. More specifically, the guide wall 70 includes a plate-shaped first guide wall 72, a second guide wall, and a plate-shaped third guide wall 76. The first guide wall 72 is arranged to the leading side of the recess 62 in the rotation direction of the crankshaft 100 (counter-clockwise in FIG. 3) and on the radially outer side of the projection 60. The first guide wall 72 projects from the opposed surface 52a of the main body 52 in the direction that is the same as the projection 60. The projecting length of the first guide wall 72 is the same as the projecting length of the projection 60. Additionally, the first guide wall 72 extends radially outward of the circular hole 58 from the outer circumferential surface of the projection 60 and is connected to the lower circumferential wall 54a. The extending direction of the first guide wall 72 is substantially orthogonal to the extending direction of the lower circumferential wall 54a.

In the present embodiment, the lower circumferential wall 54a projects from the main body 52 in the same direction as the projection 60 at a position outward of (or below) the recess 62 in the radial direction of the circular hole 58. Furthermore, the lower circumferential wall 54a extends from the trailing side of the recess 62 in the rotation direction of the crankshaft 100 toward the leading side in the rotation direction. The lower circumferential wall 54a is connected to the first guide wall 72 as described above. Thus, the lower circumferential wall 54a also functions as the second guide wall in the present embodiment.

The third guide wall 76 extends from the inner surface (upper surface) of the lower circumferential wall 54a toward the projection 60. The upper end of the third guide wall 76 is connected to the distal end of the projection 60. Furthermore, the third guide wall 76 extends from the trailing side of the recess 62 in the rotation direction of the crankshaft 100 toward the leading side in the rotation direction and is connected to the distal end of the first guide wall 72. The third guide wall 76 is arranged to be parallel to the opposed surface 52a of the main body 52. That is, the third guide wall 76 is arranged to be opposed to the opposed surface 52a and is connected to the projection 60, the lower circumferential wall 54a, and the first guide wall 72. The third guide wall 76 extends between the projection 60 and the lower circumferential wall 54a from the trailing side of the recess 62 in the rotation direction of the crankshaft 100 toward the leading side in the rotation direction and is connected to the first guide wall 72. In other words, the third guide wall 76 closes the space surrounded by the first guide wall 72, the second guide wall, the main body 52, and the projection 60 from the position opposite from the main body 52.

The first guide wall 72, the second guide wall, the third guide wall 76, the main body 52, and the projection 60 define an air inlet chamber K. The air inlet chamber K is arranged radially outward of the circular hole 58 from the recess 62. The air inlet chamber K has an opening on the trailing side of the recess 62 in the rotation direction of the crankshaft 100. The opening is defined by the lower circumferential wall 54a, the third guide wall 76, the main body 52, and the projection 60.

In the present embodiment, the first guide wall 72 and the third guide wall 76 are molded separately from the main body 52, the projection 60, and the circumferential wall 54 and are mounted on the main body 52, the projection 60, and the circumferential wall 54 with, for example, adhesive.

Operation and advantages of the present embodiment will now be described.

(1) When the crankshaft 100 rotates, the temperature of the seal lip 44 of the sealing member 40 may increase due to friction between the seal lip 44 and the flange 100e. When the temperature of the seal lip 44 is excessively increased, the seal lip 44 may possibly be damaged due to thermal expansion or melting. In this case, the flange 100e and the inner circumferential surface of the circular hole 58 of the seal retainer 50 are no longer hermetically sealed.

When the crankshaft 100 rotates, swirling air occurs on the radially outer side of the projection 60 of the seal retainer 50 in accordance with the rotation. In the present embodiment, the recess 62 is provided at a part of the projection 60, and the guide wall 70 is provided outward of the recess 62 in the radial direction of the circular hole 58. Thus, the swirling air caused in accordance with the rotation of the crankshaft 100 is guided from the radially outer side of the projection 60 to the radially inner side of the projection 60 through the recess 62. More specifically, the air inlet chamber K is defined by the first guide wall 72, the second guide wall, the third guide wall 76, the main body 52, and the projection 60 outward of the recess 62 in the radial direction of the circular hole 58. The air inlet chamber K is open on the trailing side of the recess 62 in the rotation direction of the crankshaft 100. Thus, when the swirling air caused by the rotation of the crankshaft 100 reaches the vicinity of the opening of the air inlet chamber K (refer to arrow W1 in FIG. 2), the swirling air flows into the air inlet chamber K through the opening. The swirling air that flowed into the air inlet chamber K flows to the radially inner side of the projection 60 through the recess 62. The swirling air that has flowed to the radially inner side of the projection 60 cools the sealing member 40. This prevents the temperature of the sealing member 40 from being excessively increased.

(2) In the present embodiment, the projection 60 includes the recess 62 at the section closest to the lower circumferential wall 54a. Thus, the projection 60 extends to approach the lower circumferential wall 54a as the projection 60 gets closer to the recess 62 on the trailing side of the recess 62 in the rotation direction of the crankshaft 100. Additionally, the center of the projection 60 is arranged closer to the lower side of the main body 52 than the center of the main body 52. Thus, the section of the projection 60 near the recess 62 is arranged relatively close to the lower circumferential wall 54a. This structure allows the air inlet chamber K to form a flow passage for the swirling air that flows in the rotation direction of the crankshaft 100. The flow passage narrows down between the lower section of the projection 60 (the section arranged on the trailing side of the recess 62 in the rotation direction of the crankshaft 100) and the lower circumferential wall 54a. That is, the cross-sectional area of the gas flow passage formed by the air inlet chamber K decreases from the opening of the air inlet chamber K (gas inlet) toward the recess 62 (gas outlet). The air velocity of the swirling air that flows through the flow passage increases toward the recess 62. Thus, the swirling air rushes into the radially inner side of the projection 60 through the recess 62 and may reach the region apart from the recess 62 in addition to the region close to the recess 62. Thus, a large part of the sealing member 40 in the circumferential direction is cooled.

(3) The flow of air pushed downward in accordance with the reciprocation of the pistons reaches the oil pan 28 from the cylinder block 10. The flow of air may further reach the inner surface of the lower circumferential wall 54a of the seal retainer 50 through the gap between the crank cap 20 and the lower circumferential wall 54a of the seal retainer 50. The recess 62 of the present embodiment is arranged at the lowest section of the projection 60, that is, the section of the projection 60 closest to the lower circumferential wall 54a. Thus, the recess 62 easily draws in the air that flows through the gap between the lower circumferential wall 54a of the seal retainer 50 and the crank cap 20. This structure increases the amount of air guided to the radially inner side of the projection 60 through the recess 62 compared with, for example, a case in which the recess 62 is provided at the uppermost section of the projection 60.

(4) In the present embodiment, the bottom surface of the recess 62 is flush with the opposed surface 52a of the main body 52. That is, the depth of the recess 62 is the maximum depth of the recess that can be formed in the projection 60. Thus, as compared with, for example, a case in which the bottom surface of the recess 62 is arranged in the middle of the projecting direction of the projection 60, the size of the recess 62 is increased, and air easily flows into the radially inner side of the projection 60 through the recess 62.

(5) The projection 60 of the seal retainer 50 functions as a guide for attaching the sealing member 40 to the circular hole 58. The projection 60 of the present embodiment includes only one recess 62. The recess 62 is arranged at the section of the projection 60 closest to the lower circumferential wall 54a, and the length of the recess 62 in the circumferential direction is relatively short. Since the projection 60 includes only one recess 62 that has a relatively short length in the circumferential direction, the projection 60 has sufficient rigidity for serving a guiding function.

The present embodiment may be modified as follows. The present embodiment and the following modifications can be combined as long as the combined modifications remain technically consistent with each other.

The guide wall 70 only needs to guide the air that flows on the radially outer side of the projection 60 to the radially inner side of the projection 60 through the recess 62, and the configuration of the above-described embodiment may be changed as required. For example, the position or the shape of the third guide wall 76 may be changed. The third guide wall 76 may be connected to the middle section of the projection 60 in the projecting direction. Alternatively, the third guide wall 76 may be tilted with respect to the opposed surface 52a of the main body 52. Alternatively, the third guide wall 76 may be provided only on the trailing side of the recess 62 in the rotation direction of the crankshaft 100 or on the leading side of the recess 62 in the rotation direction of the crankshaft 100.

The position or the shape of the first guide wall 72 may be changed. For example, the extending direction of the first guide wall 72 may be tilted with respect to the lower circumferential wall 54a. Alternatively, the projecting length of the first guide wall 72 does not necessarily have to be the same as the projecting length of the projection 60 and may be, for example, shorter than the projecting length of the projection 60. In this case, although there may be a gap between the distal end of the first guide wall 72 and the third guide wall 76, the first guide wall 72 inhibits the air that flows on the radially outer side of the projection 60 from escaping to the leading side of the recess 62 in the rotation direction of the crankshaft 100.

In the above-described embodiment, a wall may be provided at the opening of the air inlet chamber K to close the opening, and the wall may include a through-hole that extends through the wall along the thickness. Air flowing on the radially outer side of the projection 60 may flow into the air inlet chamber K through the through-hole.

One of the first guide wall 72 and the third guide wall 76 may be omitted.

Instead of or in addition to the first guide wall 72 and the third guide wall 76, a different guide wall may be provided. More specifically, as shown in FIG. 4, the guide wall 70 may be a guide wall (hereinafter, referred to as a tilted guide wall 78) that extends from the trailing side of the recess 62 in the rotation direction of the crankshaft 100 toward the leading side of the recess 62 in the rotation direction of the crankshaft 100 to approach the recess 62 (to separate from the lower circumferential wall 54a). More specifically, the tilted guide wall 78 projects from the opposed surface 52a of the main body 52 in the same direction as the projection 60. The projecting length of the tilted guide wall 78 substantially matches with the projecting length of the projection 60. A first end of the tilted guide wall 78 is connected to the lower circumferential wall 54a on the trailing side of the recess 62 in the rotation direction of the crankshaft 100. A second end of the tilted guide wall 78 is connected to the leading one of the two edges of the recess 62 arranged in the rotation direction of the crankshaft 100. When viewed from the cylinder block 10, the tilted guide wall 78 gently curves toward the lower circumferential wall 54a. Even if the tilted guide wall 78 as described above is employed, the air flowing on the radially outer side of the projection 60 is introduced to the radially inner side of the projection 60 through the recess 62.

Furthermore, the dimension or the arrangement of the tilted guide wall 78 shown in FIG. 4 may be changed as required. For example, the first end of the tilted guide wall 78 does not necessarily have to be connected to the lower circumferential wall 54a, and the second end of the tilted guide wall 78 does not necessarily have to be connected to the edge of the recess. When viewed from the cylinder block 10, the tilted guide wall 78 may extend straight.

Various guide walls 70 such as the tilted guide wall 78, the first guide wall 72, and the third guide wall 76 may be formed integrally with the main body 52 or the projection 60.

The depth of the recess 62 may be changed. The shape of the recess 62 may be changed. The recess 62 may be, for example, V-shaped in a plan view. In a case in which the depth or the shape of the recess 62 is changed, the structure of the guide wall 70 only needs to be changed in such a manner that air is introduced from the radially outer side of the projection 60 to the radially inner side of the projection 60 through the changed recess 62.

The position or the number of the recess 62 may be changed. When the position or the number of the recess 62 is changed, the position or the number of the guide wall 70 only needs to be changed in accordance with the position or the number of the recess 62 that has been changed.

The entire shape of the seal retainer 50 may be changed as required. The seal retainer 50 may have any shape as long as the seal retainer 50 can be mounted on the outer surface 18 of the cylinder block 10 while retaining the sealing member 40 located on the outer circumferential surface of the flange 100e of the crankshaft 100. For example, the main body 52 may be provided with a recess or a rib. The outer shape of the main body does not necessarily have to be a pentagon and may be other polygons. When the outer shape of the main body is changed, the circumferential wall only needs to be provided along the sides forming the outer edge of the main body. The rim only needs to be provided at the section of the circumferential wall that needs to abut against the outer surface 18 of the cylinder block 10.

The sealing member is not limited to the one that is configured with the metal core 42 and the seal lip 44. The sealing member only needs to close the space between the inner circumferential surface of the circular hole 58 of the seal retainer 50 and the outer circumferential surface of the flange 100e of the crankshaft 100. The sealing member may be formed of, for example, only an elastic body.

1. A seal retainer for an internal combustion engine, the engine including a cylinder block, a crankshaft having a first end projecting from an outer surface of the cylinder block in an axial direction and a flange extending radially outward from an outer circumferential surface of the first end, and an annular sealing member arranged around an outer circumferential surface of the flange, the seal retainer comprising:
a plate-shaped main body arranged to be opposed to the outer surface of the cylinder block, and
a guide wall, wherein
the main body includes
a circular hole extending through the main body,
an opposed surface opposed to the cylinder block, and
a projection, which projects from the opposed surface toward the cylinder block and extends along an inner circumferential edge of the circular hole,
the flange is arranged in the circular hole with the sealing member located between an inner circumferential surface of the circular hole and the outer circumferential surface of the flange,
the projection includes a recess at a part of the projection in a circumferential direction of the circular hole, the recess extending from a distal end of the projection in an opposite direction from the cylinder block, and
the guide wall is arranged outward of the recess in a radial direction of the circular hole to guide air that flows in the circumferential direction of the circular hole from a radially outer side of the projection to a radially inner side of the projection through the recess.

2. The seal retainer according to claim 1, wherein
the guide wall includes
a first guide wall arranged at a leading side of the recess in a rotation direction of the crankshaft, the first guide wall projecting in a projecting direction of the projection from the main body and extending radially outward of the circular hole from an outer circumferential surface of the projection,
a second guide wall projecting from the main body in the projecting direction of the projection, the second guide wall extending from a trailing side of the recess to the leading side of the recess in the rotation direction and being connected to the first guide wall, and
a third guide wall closing a space surrounded by the first guide wall, the second guide wall, the main body, and the projection from a position opposite from the main body.

3. The seal retainer according to claim 2, wherein the third guide wall is arranged to be opposed to the main body and is connected to the projection, the second guide wall, and the first guide wall.

4. The seal retainer according to claim 2, wherein the first guide wall, the second guide wall, the third guide wall, the main body, and the projection form an air inlet chamber, the air inlet chamber including an opening on the trailing side of the recess in the rotation direction.

5. The seal retainer according to claim 4, wherein
the air inlet chamber forms a flow passage for gas that flows from the opening toward the recess, and
the flow passage has a cross-sectional area that decreases from the opening toward the recess.
